(19) United States
(12) Patent Application Publication
(10) Pub. No.: US 2025/0214115 A1
(43) Pub. Date: Jul. 3, 2025

(54) CONVEYANCE SECTION CLEANING DEVICE AND IMAGE FORMING APPARATUS

(71) Applicant: Konica Minolta, Inc., Tokyo (JP)

(72) Inventor: Tatsuro OOISHI, Tokyo (JP)

(21) Appl. No.: 18/967,741

(22) Filed: Dec. 4, 2024

(30) Foreign Application Priority Data
Dec. 27, 2023 (JP) 2023-221928

(51) Int. Cl. B08B 1/32; B65H 5/22; B65H 15/00

(52) U.S. Cl. CPC B08B 1/32; B65H 5/224; B65H 15/00; B65H 2601/2611; B65H 2801/21

(57) ABSTRACT

A conveyance section cleaning device includes a recording medium conveyance unit that sucks and conveys a recording medium, a cleaning section that cleans the recording medium conveyance unit, and a controller that controls the cleaning section. If the recording medium is changed to one with a different size, the controller causes the cleaning section to clean the recording medium conveyance unit before printing starts.

### CROSS REFERENCE TO RELATED APPLICATION

The present invention claims priority under 35 U.S.C. § 119 to Japanese Patent Application No. 2023-221928, filed on Dec. 27, 2023, the entire content of which is incorporated herein by reference.

### TECHNICAL FIELD

The present invention relates to a conveyance section cleaning device including a cleaning section that cleans a recording medium conveyance unit, and an image forming apparatus.

### BACKGROUND OF THE INVENTION

In general, a printing apparatus conveys a printing sheet while sucking and fixing the printing sheet through a porous sheet. A suction surface that sucks a printing sheet has a reduced suction performance when the suction surface is contaminated with foreign substances such as paper dust and ink mist. In such a case, there has been a problem in that the image quality of the printed surface deteriorates due to lifting or peeling of the sheet.

In addition, because the ink jet head of the printing apparatus rubs the sheet surface, the head is damaged. In such a case, adjustment of printing accuracy, replacement of the head, and the like are required, which disadvantageously affects downtime and replacement costs.

Further, when foreign substances such as paper dust adhere to a sheet surface at the time of double-sided printing, there is a problem that an image defect occurs on the printed surface.

Conventionally, an image forming apparatus has been known as a printing apparatus having a function of removing such foreign substance and stains adhering to the printing sheet and the inkjet head.

In an image forming apparatus described in JP 2009-274272 A, a recording medium is ejected after image formation, a conveyance drum is cleaned by a cleaning roller, and air is ejected and blown in the subsequent region, so that a foreign substance is removed in the suction pipe path having suction holes.

A cleaning device described in JP 2020-142873 A includes a first cleaning section that passes a gas through suction holes of the conveyance belt, and a second cleaning section that is arranged on a downstream side in the conveyance direction and wipes the conveyance surface with a contact member, so that the conveyance surface and the suction holes of the conveyance belt are cleaned by the cleaning device.

An inkjet printing apparatus described in JP 2020-069794 A includes a conveyance belt to convey a printing medium, an inkjet head to print on the printing medium, a cleaning operation section to clean the inkjet head, and a controller. The controller acquires the cumulative time of the suction operation. When the acquired cumulative time reaches a threshold value, the controller controls the cleaning operation section to perform cleaning, thereby preventing soiling of the printing paper due to the ink collecting on the nozzle surface.

### SUMMARY OF THE INVENTION

However, in the above-described image forming apparatus or similar devices, as the number of printed sheets increases, the amount of dust or the like also increases, requiring more frequent cleaning in proportion to the number of printed sheets. For this reason, the conventional image forming apparatus or similar devices is time-consuming, as the cleaning frequency must be increased accordingly.

Further, in the image forming apparatus or similar devices, because the cleaning area changes according to the size of the sheet, the operation must be stopped each time, and the cleaning must be adjusted to match the sheet size.

The present invention has been made in view of the above-described problems, and an object of the present invention is to provide a conveyance section cleaning device and an image forming apparatus capable of removing stains adhering to the recording medium conveyance unit.

To achieve at least one of the abovementioned objects, according to an aspect of the present invention, a conveyance section cleaning device reflecting one aspect of the present invention comprises: a recording medium conveyance unit that sucks and conveys a recording medium; a cleaning section that cleans the recording medium conveyance unit; and a controller that controls the cleaning section; wherein if the recording medium is changed to one with a different size, the controller causes the cleaning section to clean the recording medium conveyance unit before printing starts.

Further, to achieve at least one of the abovementioned objects, according to an aspect of the present invention, an image forming apparatus reflecting one aspect of the present invention comprises: the conveyance section cleaning device as described above, and an image forming section that forms an image on the recording medium supplied from the recording medium conveyance unit.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a schematic configuration diagram illustrating an overall configuration of an inkjet recording apparatus according to an embodiment of the present invention and illustrates a state when a recording medium is conveyed toward a non-defective sheet ejection unit.

FIG. 2 is a schematic configuration diagram illustrating the overall configuration of the inkjet recording apparatus according to the embodiment and illustrates a state when a recording medium is conveyed toward a front/back reversing unit.

FIG. 3 is a schematic configuration diagram illustrating the overall configuration of the inkjet recording apparatus according to the embodiment and illustrates a state in which a recording medium is being reversed to print on both sides.

FIG. 4 is a schematic configuration diagram illustrating the overall configuration of the inkjet recording apparatus according to the embodiment and illustrates a state when a reversed recording medium is fed out toward a delivery roller.

FIG. 5 is a schematic plan view showing a state in which a cleaning roller is disposed at positions corresponding to both end portions in the width direction of the recording medium.

FIG. 6 is a schematic plan view showing a state in which a cleaning roller is disposed at positions corresponding to both end portions in the width direction of the recording medium and a trailing end portion in the conveying direction of the recording medium.

### DETAILED DESCRIPTION

Hereinafter, one or more embodiments of the present invention will be described with reference to the drawings. However, the scope of the invention is not limited to the disclosed embodiments.

An embodiment of the present invention will be described in detail with reference to appropriate drawings. Note that common members are denoted by the same reference signs in the drawings.

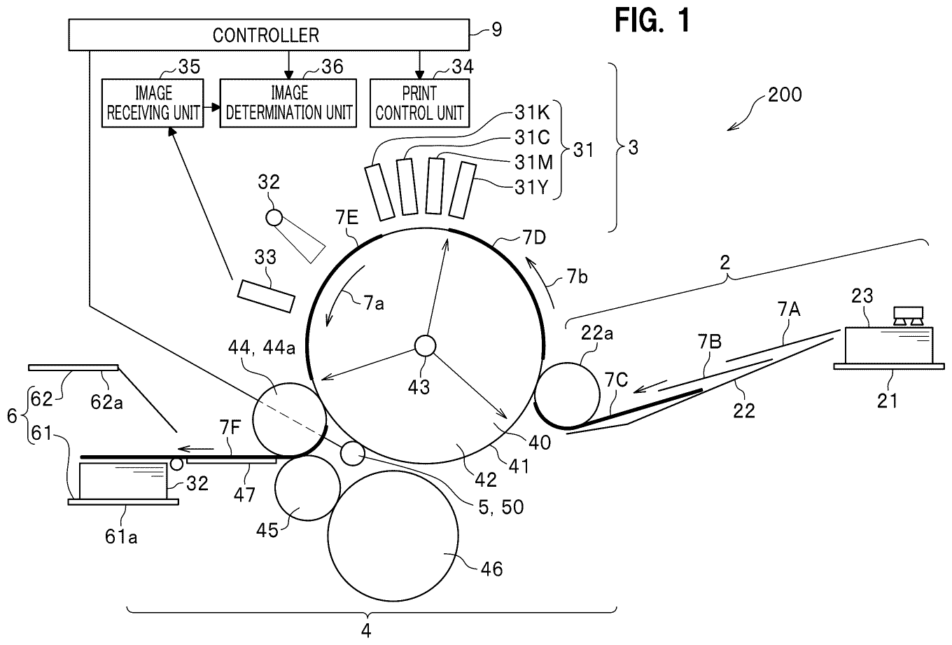

FIG. 1 is a schematic configuration diagram illustrating an overall configuration of an inkjet recording apparatus 200 according to one embodiment of the present invention.

### <Recording Medium>

Before describing the inkjet recording apparatus 200 shown in FIG. 1, a recording medium 23 used in this apparatus will be described. The recording medium 23 is, for example, a recordable and storable medium such as sheet, fabric, plastic film, and glass plate. The recording medium 23 may be any medium on the surface of which an image can be formed. In this embodiment, a sheet is used as an example of the recording medium 23.

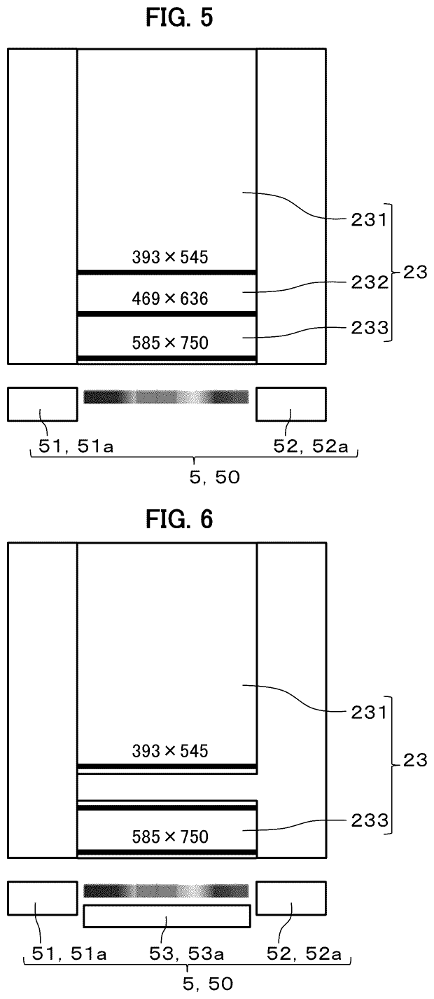

As illustrated in FIG. 5, the recording medium 23 may be any one of the following three sizes: for example, a recording medium 231 of 393 mm×545 mm, a recording medium 232 of 469 mm×636 mm, and a recording medium 233 of 585 mm×750 mm.

### <<Image Forming Apparatus>>

As an example of the image forming apparatus, an inkjet recording apparatus will be described.

### <<Inkjet Recording Apparatus>>

An inkjet recording apparatus 200 shown in FIG. 1 forms (records) an image on the recording medium 23 by ejecting ink from the nozzles 31Y, 31M, 31C, and 31K of a carriage 31. The inkjet recording apparatus 200 is an apparatus that forms an image on a recording medium 23 by, for example, a one pass inkjet method. The inkjet recording apparatus 200 is a recording apparatus that ejects ink from nozzles 31Y, 31M, 31C, and 31K provided in an inkjet head to form an image on a recording medium 23 such as a sheet. The inkjet recording apparatus 200 is, for example, a color inkjet recording apparatus that superposes inks of four colors of black, yellow, cyan, and magenta.

The inkjet recording apparatus 200 includes a sheet feed section 2, a recording medium feeding unit 22, an image forming section 3, a conveyance mechanism 4, a cleaning section 5, a sheet ejection section 6, and an ink supply tank (not illustrated). The inkjet recording apparatus 200 forms image data input from an external device on a recording medium 23.

### <Ink and Ink Supply Tank>

Ink used is in a gel state at normal temperature and is softened at high temperature. The ink is heated to a temperature exceeding a melting temperature by a heater (not illustrated). A predetermined amount of ink is stored in an ink supply tank (not illustrated). The ink supply tank (not illustrated) is an ink storage tank for supplying ink to the image forming section 3.

An inkjet recording apparatus 200 as an image forming apparatus includes a conveyance section cleaning device. The conveyance section cleaning device is a device that cleans, with a cleaning section 5, foreign substances such as paper dust and ink stains adhering to a conveyance drum 40 as a recording medium conveyance unit.

### <Sheet Feed Section>

As illustrated in FIG. 1, the sheet feed section 2 is a supply unit that supplies a sheet as a recording medium 23. The sheet feed section 2 includes a recording medium feeding tray 21. The recording medium feeding tray 21 is formed of a plate-like member provided so that recording media 23 (sheets) can be placed thereon. The recording medium feeding tray 21 is provided so as to be movable in the vertical direction in accordance with the number of the recording media 23 placed thereon. The recording media 23 placed on the recording medium feeding tray 21 are held at a position where the uppermost recording medium 23 is conveyed by the recording medium feeding unit 22.

### <Recording Medium Feeding Unit>

The recording medium feeding unit 22 is a recording medium conveyance unit that conveys the uppermost recording medium 23 placed on the recording medium feeding tray 21 toward the image forming section 3 and delivers the recording medium 23 to a conveyance drum 40 of the image forming section 3 via a delivery roller 22a. The recording medium feeding unit 22 is disposed between the sheet feed section 2 and the image forming section 3. The recording medium feeding unit 22 includes a delivery roller 22a.

### <Conveyance Mechanism>

The conveyance mechanism 4 illustrated in FIG. 1 receives and sucks the recording medium 23 supplied from the recording medium feeding unit 22 with a conveyance drum 40 and conveys the recording medium 23 to a position opposite to the image forming section 3. Then, the sheet is conveyed to a sheet ejection section 6 or a front/back reversing unit 46 via a sheet ejection/reversal switching unit 44. The conveyance mechanism 4 is configured to include a rotation drive unit (unillustrated), the conveyance drum 40 as a recording medium conveyance unit, a sheet ejection/reversal switching unit 44, a sheet ejection reverse conveyance roller 45, a front/back reversing unit 46, a sheet ejection destination switching unit 47, and a controller 9. The delivery roller 22a, the nozzles 31Y, 31M, 31C, and 31K, a fixing unit 32, an image reading unit 33, a sheet ejection/reversal switching unit 44, a front/back reversing unit 46, and a cleaning section 5 are arranged opposite to the outer peripheral surface of the conveyance drum 40.

### <Conveyance Drum>

The conveyance drum 40 illustrated in FIG. 1 constitutes a recording medium conveyance unit. The recording medium conveying unit adsorbs the recording medium 23 received from the recording medium feeding unit 22 and conveys the recording medium 23 toward the opposite position of the image forming section 3 and the sheet ejection/reversal switching unit 44. The conveyance drum 40 is a drum unit and is a recording medium conveyance member for air-adsorbing and conveying a recording medium 23. The conveyance drum 40 includes a conveyance cylinder 41 formed of a hollow cylindrical drum, a lid-shaped support portion 42 that closes an opening of the conveyance cylinder 41, and a rotary shaft 43. The conveyance drum 40 is formed in a hollow cylindrical shape.

The conveyance drum 40 rotates and conveys the recording medium 23 while winding the recording medium 23 supplied from the sheet feed section 2 around the outer peripheral surface of the conveyance drum 40. Therefore, a conveyance surface for conveying the recording medium 23 is formed by the outer peripheral surface of the conveyance drum 40. The conveyance drum 40 holds the recording medium 23 against its outer peripheral surface, for example, by air suction, and rotates in this state to convey the recording medium 23 in the direction of the arrow 7b.

### <Conveyance Cylinder>

The conveyance cylinder 41 is a cylindrical member that forms the outer peripheral surface of the conveyance drum 40. The conveyance cylinder 41 is formed of a mesh-like plate member made of stainless steel or the like having a large number of suction holes (for example, formed of through holes of ϕ1 mm) (not illustrated) for adsorbing the recording medium 23. A porous Perfluoro alkoxy alkane (PFA) sheet made of resin is placed on the plate member so that the suction holes in the adsorption surface do not affect printing. To enable satisfactory suction of the recording medium 23 of multiple sizes, the conveyance cylinder 41 closes the suction holes in the area outside the sizes (in the vicinity of both ends of the recording medium 23 in the width direction) to increase the suction force. The inkjet conveyance cylinder 41 uses ink that softens at high temperature. The conveyance cylinder 41 suctions dirt from suction holes (not illustrated) while heating the conveyance drum 40 with a heater (not illustrated). Then, dirt adhering to suction holes (not illustrated) of the conveyance cylinder 41 is removed by the cleaning section 5.

The conveyance cylinder 41 uses air suction to suck the recording medium 23 to the suction holes (not illustrated), thus allowing the recording medium 23 to be conveyed in close contact with the conveyance cylinder 41 while preventing the recording medium 23 from lifting. Therefore, the conveyance cylinder 41 can convey the recording medium 23 without slipping. The conveyance cylinder 41 can prevent the recording medium 23 from coming into contact with the nozzles 31Y, 31M, 31C, and 31K in cases where the recording medium 23 experiences so-called sheet floating, thereby preventing image defects and damage to the nozzles.

The rotary shaft 43 is provided along the central axis of the conveyance drum 40 and protrudes axially from the support portion 42. The rotary shaft 43 is rotatably supported by a pair of bearing members (not illustrated). A rotary drive unit (not illustrated), for example, is connected to one end of the rotary shaft 43 via a reduction gear mechanism (not illustrated). When the rotary drive unit (not illustrated) is driven, the rotary drive unit rotates the rotary shaft 43 and the conveyance drum 40.

### <Image Forming Section>

As shown in FIG. 1, the image forming section 3 is an image forming unit that forms an image using ink on a recording medium 23 supplied from the recording medium feeding unit 22. The image forming section 3 includes the carriage 31, the conveyance mechanism 4, the fixing unit 32, the image reading unit 33, and the controller 9.

### <Carriage>

As illustrated in FIG. 1, the carriage 31 includes, for example, four nozzles 31Y, 31M, 31C, and 31K. The carriage 31 is supported by a support member (not illustrated) such that the nozzles 31Y, 31M, 31C, and 31K face the outer peripheral surface of the conveyance drum 40. The carriage 31 is driven by the print control unit 34 and ejects ink from the nozzles 31Y, 31M, 31C, and 31K onto the recording medium 23.

### <Nozzles>

As shown in FIG. 1, the inkjet head having the nozzle 31Y ejects yellow ink onto a recording medium 23 to form an image. The inkjet head having the nozzle 31M ejects magenta ink onto a recording medium 23 to form an image. The inkjet head having the nozzle 31C ejects the cyan ink onto a recording medium 23 to form an image. The inkjet head having the nozzle 31K ejects black ink onto a recording medium 23 to form an image. Note that a case where ultraviolet curable ink is used in the inkjet recording apparatus 200 will be described as an example.

The plurality of nozzles 31Y, 31M, 31C, and 31K are arranged above the conveyance drum 40 at appropriate intervals in the peripheral direction.

In the inkjet recording apparatus 200 of the present embodiment, four nozzles 31Y, 31M, 31C, and 31K are provided in the image forming section 3 in order to form an image using four colors of ink. However, the number of nozzles may be changed as appropriate. Hereinafter, the carriage 31 including the four nozzles 31Y, 31M, 31C, and 31K will be described as an example.

### <Fixing Unit>

The fixing unit 32 shown in FIG. 1 is a unit that cures and fixes the ink on the recording medium 23 by irradiating the recording medium 23 conveyed by the rotation of the conveyance drum 40 with ultraviolet rays. The conveyance drum 40 suctions the recording medium 23 by air. The ink on the recording medium 23 refers to ink forming an image on the recording medium 23. The fixing unit 32 has a function of fixing an image formed on the recording medium 23 using ink to the recording medium 23. The fixing of the image by the fixing unit 32 is not limited to a UV (ultraviolet) lamp or similar device that emits ultraviolet rays, and may use other devices, such as a device that irradiates energy rays capable of curing the ink in accordance with the properties of the ink, and a device that dries the ink by heating the recording medium 23.

### <Image Reading Unit>

The image reading unit 33 is a device that reads an image formed on a recording medium 23. The image reading unit 33 is disposed at a position facing the outer peripheral surface of the conveyance cylinder 41, downstream of the fixing unit 32, in the conveyance direction of the recording medium 23. The image reading unit 33 outputs a result of the read image to the image receiving unit 35. The image reading unit 33 includes, for example, a linear image sensor in which a plurality of imaging elements such as charge-coupled device (CCD) image sensors are arranged, a generation unit that generates image data from the imaging elements, and a light source that irradiates the recording medium 23 with light.

### <Image Receiving Unit and Image Determination Unit>

The image receiving unit 35 is a device that receives an image from the image reading unit 33. The image determination unit 36 determines whether the recording medium 23 is a normally printed recording medium 23 in which the image of the recording medium 23 satisfies a predetermined image condition, or a defective recording medium 23 which is waste sheet to which foreign substances such as paper dust, dirt, and the like adhere. The determination result of the image determination unit 36 is sent to the sheet ejection destination switching unit 47 via the controller 9.

### <Sheet Ejection/Reversal Switching Unit>

The sheet ejection/reversal switching unit 44 shown in FIG. 1 is a conveyance destination switching unit that directs the recording medium 23 from the conveyance mechanism 4 either toward the sheet ejection section 6 or toward the front/back reversing unit 46. The sheet ejection/reversal switching unit 44 includes a reverse conveyance roller 44a for conveying the recording sheet 23. At an outer peripheral portion of the conveyance cylinder 41, the sheet ejection/reversal switching unit 44 is arranged on the downstream side in the direction of the arrow 7a that is the conveyance direction of the conveyance drum 40.

### <Sheet Ejection Reverse Conveyance Roller>

The sheet ejection reverse conveyance roller 45 is a roller for conveying a recording medium 23 toward the sheet ejection section 6 or for reversing the recording medium 23 and conveying it in the direction of the front/back reversing unit 46. The sheet ejection reverse conveyance roller 45 is disposed at a position where the recording medium 23 fed from the conveyance drum 40 toward the sheet ejection section 6 can be nipped between the sheet ejection/reversal switching unit 44 and the sheet ejection reverse conveyance roller 45.

### <Front/Back Reversing Unit>

The front/back reversing unit 46 illustrated in FIG. 1 is a reversing unit for reversing the front and back of the recording medium 23 in order to form images on both sides of the recording medium 23. The front/back reversing unit 46 is provided between the sheet ejection/reversal switching unit 44 and the sheet feed section 2 in order to perform double-sided printing. The front/back reversing unit 46 is disposed so as to reverse the recording medium 23 sent from the sheet ejection/reversal switching unit 44 and send the recording medium 23 to the delivery roller 22a side of the outer peripheral surface of the conveyance drum 40.

### <Sheet Ejection Destination Switching Unit>

The sheet ejection destination switching unit 47 is a switching unit that switches the sheet ejection destination of the recording medium 23. The sheet ejection destination switching unit 47 is a device that switches the sheet ejection destination to either a non-defective sheet ejection unit 61 in which the recording medium 23 on which printing is normally performed is accumulated or a defective sheet ejection unit 62 in which waste sheet which cannot be used as a product in a printing process is accumulated. The switching of the sheet ejection destination between the non-defective sheet ejection unit 61 and the defective sheet ejection unit 62 by the sheet ejection destination switching unit 47 is performed according to an instruction of the controller 9.

### <Conveyance Section Cleaning Device>

The inkjet recording apparatus 200 includes a conveying unit cleaning device. The conveying unit cleaning device includes a cleaning section 5 shown in FIG. 1. The cleaning section 5 is a cleaning unit for cleaning foreign substances such as paper dust adhering to the surface of the conveyance drum 40 constituting the recording medium conveyance unit, and contamination due to ink mist. The cleaning section 5 includes, for example, a cleaning roller 50 to clean the conveyance drum 40. The cleaning section 5 is provided upstream of the front/back reversing unit 46 that reverses the recording medium 23 on the outer peripheral portion of the conveyance cylinder 41.

The cleaning roller 50 is a roller having a cleaning surface on the outer peripheral portion thereof for cleaning foreign substances such as paper dust and dirt such as ink mist adhering to the conveyance drum 40. The cleaning surface is formed with a material having a high surface adhesion force to which foreign substances such as paper dust and dirt such as ink mist adhere. The cleaning surface is formed in a sheet shape or a layer shape on the outer peripheral surface of the cleaning roller 50. Examples of the material having a high surface adhesion force include polyimide resin, nylon resin, polyester resin, polyurethane resin, polycarbonate resin, polyimide resin, and nylon resin.

The cleaning surface may be provided with a woven fabric, a nonwoven fabric, a sponge, or the like which is a member having high ink absorbency.

FIG. 5 is a schematic plan view showing a state in which the cleaning roller 50 is disposed at positions (end portions 51, 52) corresponding to both end portions in the width direction of the recording medium 23.

As shown in FIG. 5, the cleaning roller 50 is disposed at end portions 51, 52 on both sides in the width direction of the recording medium 23 where foreign substances such as paper dust and dirt such as ink are likely to adhere. Cleaning portions 51a and 52a at the opposite end portions 51, 52 allow the cleaning roller 50 to efficiently clean the widthwise opposite end regions of the recording sheet 23 to which a foreign substance or the like tends to adhere.

FIG. 6 is a schematic plan view showing a state in which the cleaning roller 50 is disposed at positions (end portions 51, 52) corresponding to both end portions in the width direction of the recording medium 23, and at a position (trailing end portion 53) corresponding to a trailing end portion in the conveyance direction of the recording medium 23.

As shown in FIG. 6, the cleaning roller 50 is arranged in sections at positions (end portions 51, 52) corresponding to end portions on both sides in the width direction of the recording medium 23, and at a position (trailing end portion 53) corresponding to the trailing end portion in the conveyance direction of the recording medium 23. At the trailing end portion 53, only a cleaning portion 53a contacts the conveyance mechanism 4.

Since the conveyance cylinder 41 of the conveyance drum 40 illustrated in FIG. 1 has three surfaces, all of the three surfaces can be cleaned by the cleaning portions 51a, 52a disposed at the end portions 51, 52 and the cleaning portion 53a disposed at the trailing end portion 53.

### <Sheet Ejection Section>

The sheet ejection section 6 illustrated in FIG. 1 is a place where a recording medium 23 such as a sheet on which an image has been formed is ejected by the conveyance mechanism 4 and is temporarily stored. The sheet ejection section 6 stores the recording medium 23 sent from the image forming section 3 via the sheet ejection/reversal switching unit 44 and the sheet ejection destination switching unit 47. The sheet ejection section 6 includes a non-defective sheet ejection unit 61 and a defective sheet ejection unit 62.

The non-defective sheet ejection unit 61 includes a flat recording medium ejection tray 61a on which non-defective recording media 23 on which images have been formed are placed. The defective sheet ejection unit 62 has a flat recording medium ejection tray 62a on which unsatisfactory recording media 23 are placed.

### <Controller>

The controller 9 shown in FIG. 1 includes a CPU (Central Processing Unit), a ROM (Read-Only Memory), a RAM (Random Access Memory), an input/output circuit and the like. The controller 9 controls the carriage 31, the fixing unit 32, the image reading unit 33, the conveyance drum 40, the sheet ejection/reversal switching unit 44, the sheet ejection reverse conveyance roller 45, the front/back reversing unit 46, the sheet ejection destination switching unit 47, and the like.

Based on the determination result of the image determination unit 36, the controller 9 controls the sheet ejection destination switching unit 47 to convey the normally printed recording medium 23 to the non-defective sheet ejection unit 61. The controller 9 further performs control to cause the unsatisfactory recording medium 23 to be conveyed to the defective sheet ejection unit 62.

Further, if the recording medium 23 is changed to one with a different size, the controller 9 causes the cleaning section 5 to clean the conveyance drum 40 (recording medium conveyance unit) before printing starts.

Further, if the recording medium 23 is changed to a larger size, the controller 9 causes the cleaning section 5 to clean the conveyance drum 40 before printing starts. On the other hand, if the recording medium 23 is changed to a smaller size, the controller 9 does not cause the cleaning section 5 to clean the conveyance drum 40.

Furthermore, the controller 9 does not cause the cleaning section 5 to clean the conveyance drum 40 if the size of the recording medium 23 is not changed.

Furthermore, the controller 9 does not cause the cleaning section 5 to perform cleaning if the number of printed sheets exceeds a preset number of printed sheets during printing.

### <<Operation of Inkjet Recording Apparatus>>

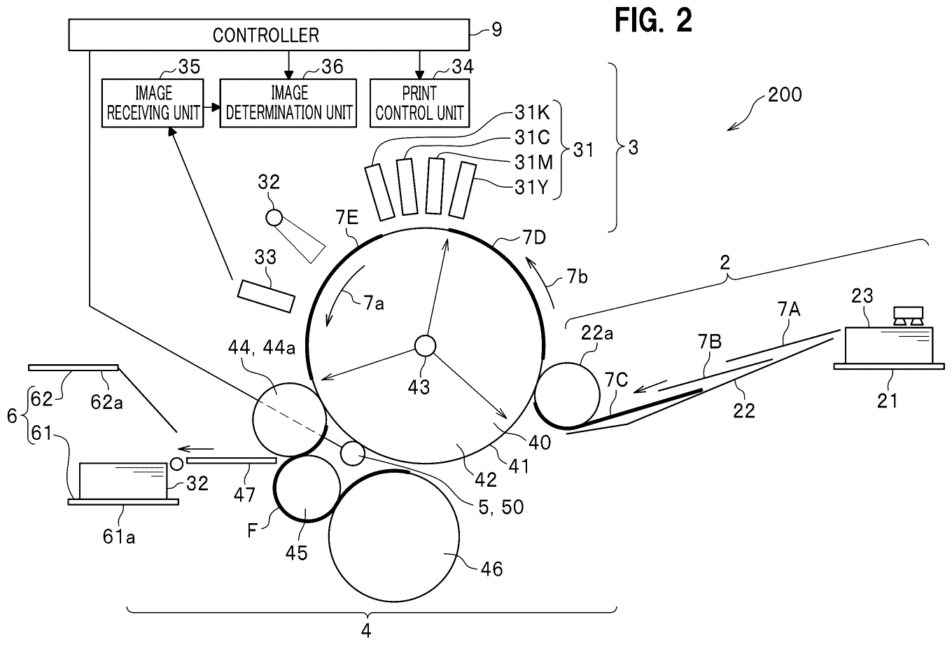

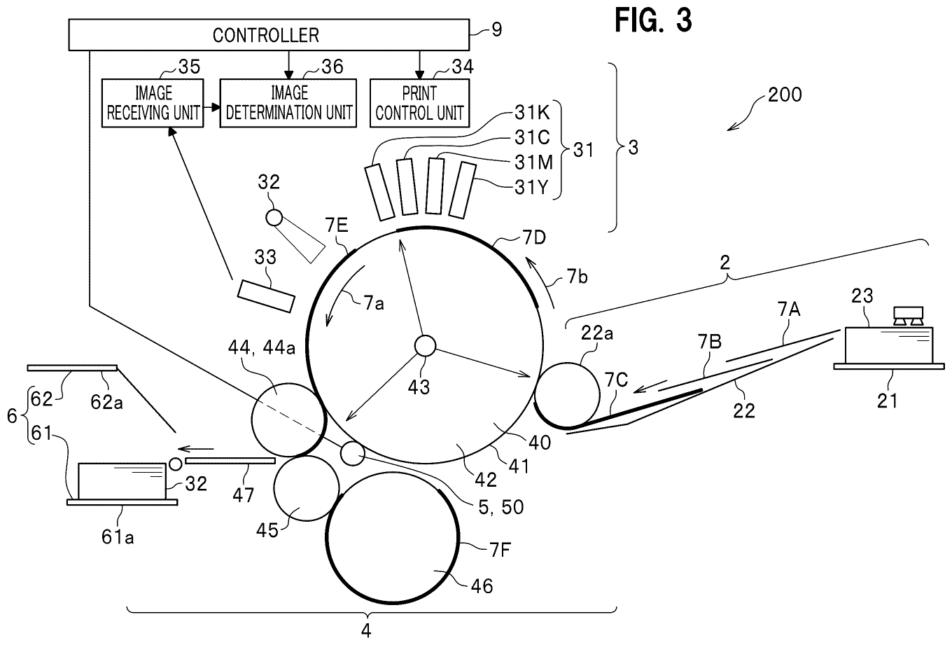

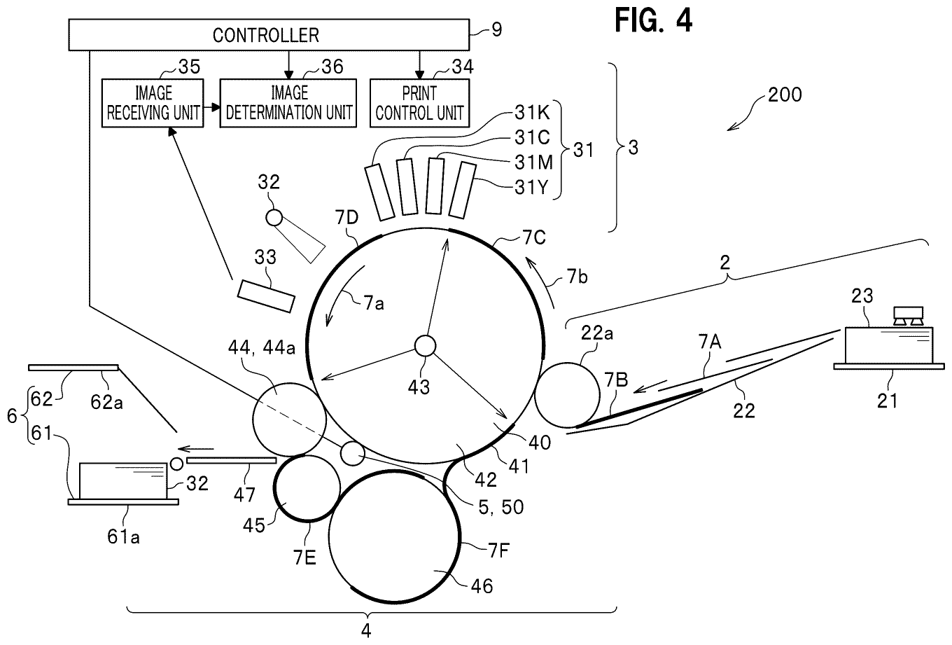

FIG. 2 is a schematic configuration diagram illustrating the overall configuration of the inkjet recording apparatus 200 according to the embodiment of the present invention and illustrates a state when a recording medium 23 is conveyed toward the front/back reversing unit 46. FIG. 3 is a schematic configuration diagram illustrating the overall configuration of the inkjet recording apparatus 200 according to the embodiment and illustrates a state in which the recording medium 23 is being reversed to print on both sides. FIG. 4 is a schematic configuration diagram illustrating the overall configuration of the inkjet recording apparatus 200 according to the embodiment and illustrates a state when the reversed recording medium 23 is fed out toward the delivery roller 22a.

Next, the operation of the inkjet recording apparatus 200 will be described with reference to FIGS. 1 to FIG. 6.

First, cleaning of the suction holes (not illustrated) of the conveyance cylinder 41 shown in FIG. 1 is started.

Ink in the carriage 31 is in a gel state at room temperature and is dissolved and becomes liquid when the temperature becomes 50° C. or higher. Therefore, the ink adhered to the conveyance cylinder 41 is heated to 50° C. or more to be brought into a liquid state, thereby being brought into an easily removable state. In a case of cleaning suction holes (not illustrated) of the conveyance cylinder 41, it is preferable to heat the conveyance cylinder 41 to a temperature (e.g., 60° C.) exceeding the melting temperature of ink by a heater (not illustrated) during non-printing and non-conveyance.

When one side of the recording medium 23 is printed by the inkjet recording apparatus 200, as shown in FIG. 1, a recording medium 23 in the sheet feed section 2 is sequentially fed to positions 7A, 7B, and 7C, and printing is performed on the front side of the recording medium 23 by the carriage 31. The printed recording medium 23 is sent to the position 7E by the conveyance drum 40 and fixed by the fixing unit 32. Then, after the printing status is read by the image reading unit 33, the recording medium 23 is sent to the position 7F of the sheet ejection section 6 via the sheet ejection/reversal switching unit 44 and the sheet ejection destination switching unit 47. When the recording medium 23 is determined as a non-defective product by the image reading unit 33, the recording medium 23 is sent from the sheet ejection destination switching unit 47 to the non-defective sheet ejection unit 61. When the recording medium 23 is determined as a defective product by the image reading unit 33, the recording medium 23 is sent from the sheet ejection destination switching unit 47 to the defective sheet ejection unit 62.

The cleaning section 5 cleans and removes foreign substances such as paper dust adhering to the periphery of the conveyance drum 40 when the conveyance drum 40 conveys the recording medium 23.

In this way, the inkjet recording apparatus 200 performs single-sided printing on the recording medium 23.

When the recording medium 23 is subject to double-sided printing by the inkjet recording apparatus 200, as shown in FIG. 2, the recording medium 23 in the sheet feed section 2 is fed to positions 7A, 7B, 7C, and 7D, and the front side of the recording medium 23 is printed by the carriage 31. The printed recording medium 23 is sent to the position 7E by the conveyance drum 40, fixed by the fixing unit 32, and the printing status is read by the image reading unit 33. Thereafter, the recording medium 23 is sent to the position 7F on the side of the sheet ejection reverse conveyance roller 45 and the front/back reversing unit 46 by the sheet ejection/reversal switching unit 44. At this time, the cleaning section 5 cleans and removes foreign substances such as paper dust adhering to the periphery of the conveyance drum 40 when the conveyance drum 40 conveys the recording medium 23.

Next, as shown in the position 7F of FIG. 3, the recording medium 23 sent to the front/back reversing unit 46 is reversed by the rotation of the front/back reversing unit 46. At this time, the cleaning section 5 cleans foreign substances such as paper dust, adhering to the conveyance drum 40 while the conveyance drum 40 conveys the recording medium 23.

Subsequently, the reversed recording medium 23 is sent to the outer peripheral surface of the conveyance drum 40 in a state where the recording medium 23 is reversed as shown in the position 7F of FIG. 4 by the rotation of the reversing unit 46. The recording medium 23 sent to the outer peripheral surface of the conveyance drum 40 is sent from the position 7F to the position 7C via the delivery roller 22a, and the back surface of the recording medium 23 is printed by the carriage 31. Even in this case, when the conveyance drum 40 conveys the recording medium 23, the cleaning section 5 cleans the attached foreign substances such as paper dust.

In this way, the recording medium 23 is subjected to double-sided printing.

As illustrated in FIG. 1, the inkjet recording apparatus 200 as an image forming apparatus according to the present invention includes the sheet feed section 2 that feeds a recording medium 23, the conveyance drum 40 that sucks and conveys the recording medium 23, the image forming section 3 that forms an image on the recording medium 23 fed from the conveyance drum 40, the cleaning section 5 that cleans the conveyance drum 40, and the controller 9 that controls the cleaning section 5. The conveyance section cleaning device according to the present invention, which forms a part of the inkjet recording apparatus 200, includes the conveyance drum 40 that sucks and conveys the recording medium 23, the cleaning section 5 that cleans the conveyance drum 40, and the controller 9 that controls the cleaning section 5.

If the recording medium 23 is changed to one with a different size, the controller 9 causes the cleaning section 5 to clean the conveyance drum 40 before printing starts.

With this configuration, when the size of the recording medium 23 is changed, the controller 9 causes the cleaning section 5 to automatically clean the recording medium conveyance unit (e.g., the conveyance drum 40) to remove foreign substances and dirt before the start of printing, thereby saving the trouble of manual cleaning. In addition, the conveyance section cleaning device can maintain the adsorption performance without skill by cleaning the conveyance drum 40. For this reason, the inkjet recording apparatus 200 as the conveyance section cleaning device and the image forming apparatus of the invention can automatically clean the conveyance surface of the conveyance drum 40, maintain the suction force of the recording medium 23, and prevent a decrease in the conveyance force so that an error due to sheet floating does not occur.

Therefore, the conveyance section cleaning device and the inkjet recording apparatus 200 according to the present embodiment can remove dirt adhering to the recording medium conveyance unit.

Further, as shown in FIG. 1, if the recording medium 23 is changed to a larger size, the controller 9 causes the cleaning section 5 to clean the conveyance drum 40 before printing starts, and if the recording medium 23 is changed to a smaller size, the controller 9 does not cause the cleaning section 5 to clean the recording medium conveyance unit.

With this configuration, when the size of the recording medium 23 has been changed to a larger size, the controller 9 allows the cleaning section 5 to clean the conveyance drum 40 before printing starts. Therefore, when printing is performed on the recording medium 23 having a large size after printing is performed on the recording medium 23 having a small size, it is possible to prevent paper dust remaining under the recording medium 23 from blocking the suction holes of the conveyance drum 40 to deteriorate the suction force, resulting in the occurrence of sheet lifting.

Further, the controller 9 does not cause the cleaning section 5 to clean the conveyance drum 40 if the size of the recording medium 23 is changed to a smaller size. Therefore, in the present invention, it is possible to maintain the adhesiveness of the cleaning section 5 to prevent a decrease in the adhesiveness when the cleaning section 5 is of an adhesive type, or to reduce the frequency of replacement of water if the cleaning section 5 is of a wet type. As a result, since the cleaning section 5 is cleaned only, when necessary, the cleaning section 5 can be efficiently cleaned, and the service life of the cleaning section 5 can be extended.

Further, as illustrated in FIG. 1, the controller 9 does not cause the cleaning section 5 to perform cleaning if the size of the recording medium 23 is not changed.

With this configuration, if the size of the recording medium 23 is not changed, foreign substances such as paper dust are unlikely to be generated on the outer peripheral surface of the conveyance drum 40, and thus the suction force does not deteriorate. For this reason, when the size of the recording medium 23 remains unchanged, unnecessary cleanings can be avoided by not cleaning the conveyance drum 40.

Further, as shown in FIG. 1, the controller 9 does not cause the cleaning section 5 to clean the recording medium conveyance unit if the number of printed sheets exceeds a preset number of printed sheets during printing.

With this configuration, the cleaning section 5 can efficiently clean the conveyance surface of the conveyance drum 40 by cleaning the conveyance drum 40 as the recording medium conveyance unit in a case where the number of printed sheets exceeds a predetermined number. For this reason, the cleaning section 5 can maintain the suction force of the conveyance drum 40 for sucking the recording medium 23 and prevent the conveyance force from decreasing.

Further, as shown in FIG. 1, the recording medium conveyance unit includes the conveyance drum 40 that conveys the recording medium 23.

With this configuration, the recording medium conveyance unit is specifically the conveyance drum 40, and it is possible to cause the ink mist to be sucked inside the conveyance drum 40 so as not to be scattered to the outer peripheral part of the conveyance drum 40. Since the recording medium conveyance unit is composed of a carrying drum 40, the conveyance path can be shortened to miniaturize the entire apparatus.

Furthermore, as illustrated in FIG. 1, the inkjet recording apparatus 200 includes the sheet ejection section 6 that ejects the recording medium 23 on which printing has been performed, the front/back reversing unit 46 that reverses the recording medium 23, and the sheet ejection/reversal switching unit 44 that directs the recording medium 23 either toward the sheet ejection section 6 or toward the front/back reversing unit 46. The front/back reversing unit 46 for double-sided printing is provided between the sheet ejection/reversal switching unit 44 and the sheet feed section 2.

With this configuration, the front/back reversing unit 46 is provided between the sheet ejection/reversal switching unit 44 and the sheet feed section 2, so that both single-sided printing and double-sided printing can be performed.

As shown in FIG. 6, the cleaning section 5 includes the cleaning roller 50 that cleans the conveyance mechanism 4, and the cleaning roller 50 is arranged in sections at positions (end portions 51, 52) corresponding to the end portions on both sides in the width direction of the recording medium 23, and at a position (trailing end portion 53) corresponding to the trailing end portion in the conveyance direction of the recording medium 23. At the trailing end portion 53, only the cleaning portion 53a contacts the conveyance mechanism 4.

With this configuration, the cleaning roller 50 is arranged in sections at the end portions 51, 52 on both sides in the width direction of the recording medium 23 and the trailing end portion 53 in the conveyance direction of the recording medium 23. Therefore, the size of the cleaning section 5 can be miniaturized as the cleaning range is limited by arranging the cleaning roller 50 in sections at the end portions 51, 52 and the trailing end portion 53.

Further, the cleaning roller 50 can appropriately clean the cleaning area, which varies depending on the size of the recording medium 23. In particular, since the cleaning portions 51a, 52a are positioned at locations corresponding to the end portions on both sides in the width direction of the recording medium 23, where paper dust and ink mist are likely to be collected, efficient cleaning can be performed. Thus, the cleaning roller 50 can perform cleaning according to the number of printed sheets and the size of the recording medium 23, thereby reducing downtime.

Further, as shown in FIG. 1, the cleaning section 5 is provided upstream, just in front of the front/back reversing unit 46 that reverses the recording medium 23.

If the cleaning section 5 is provided between the front/back reversing unit 46 and the delivery roller 22a of the sheet feed section 2 in the outer peripheral part of the conveyance drum 40, the cleaning section 5 cannot perform cleaning in the double-sided printing. Providing the cleaning section 5 upstream, just in front of the front/back reversing unit 46 makes it possible to efficiently clean the conveyance mechanism 4 at the time of single-sided printing and double-sided printing.

As shown in FIG. 1, the inkjet recording apparatus 200 includes the conveyance section cleaning device and the image forming section 3 that forms an image on the recording medium 23 supplied from the conveyance drum 40.

With this configuration, the inkjet recording apparatus 200 can efficiently form an image on a recording medium 23 while conveying the recording medium 23. Further, the inkjet recording apparatus 200 can efficiently clean foreign substances such as paper dust and dirt generated when an image is formed.

### FIRST MODIFIED EXAMPLE

Although the embodiments of the present invention have been described above, the present invention is not limited to the above-described embodiment and can be appropriately modified without departing from the gist of the present invention.

For example, the conveyance mechanism 4 including the conveyance drum 40 shown in FIG. 1 may include a conveyance roller (not illustrated) that conveys a recording medium 23.

With this configuration, since the conveying mechanism 4 includes the conveyance roller, it is possible to easily convey the recording medium 23 along a conveying surface thereof by using an adhesive member, a high-friction member, a rough-surfaced member, or other similar means on the conveying surface.

### SECOND MODIFIED EXAMPLE

The conveyance mechanism 4 illustrated in FIG. 1 may be a conveyance device configured to include a conveyance belt (not illustrated) that conveys a recording medium 23.

With this configuration, since the conveyance mechanism 4 includes the conveyance belt, it is possible to easily bring the surface of the conveyance belt into contact with the conveyance mechanism 4 and thus to efficiently perform cleaning.

### THIRD MODIFIED EXAMPLE

The cleaning section 5 shown in FIG. 1 may include an adhesive roller (not illustrated) that cleans the conveyance mechanism 4.

The adhesive roller has an adhesive surface on the outer peripheral surface of the roller. The adhesive surface is configured to adhere foreign substances such as paper dust adhering to the conveyance drum 40. The adhesive surface is formed by sticking a replaceable adhesive sheet to the outer peripheral surface of the adhesive roller.

With this configuration, since the cleaning section 5 includes the adhesive roller, foreign substances such as paper dust adhering to the conveyance mechanism 4 can be cleaned by adhering the foreign substance to the adhesive surface of the adhesive roller. Replacing the adhesive sheet at appropriate intervals makes it possible to maintain its adhesive force, even if the adhesive force of the adhesive sheet on the outer peripheral surface of the adhesive roller has decreased.

### FOURTH MODIFIED EXAMPLE

Further, the cleaning section 5 shown in FIG. 1 may include an air ejecting unit (not illustrated) that ejects air for cleaning the conveyance mechanism 4.

With this configuration, since the cleaning section 5 includes the air ejecting unit, it is possible to efficiently remove and clean foreign substances such as paper dust by blowing the air ejected from the air ejecting unit to the conveyance mechanism 4.

### FIFTH MODIFIED EXAMPLE

Further, the cleaning section 5 illustrated in FIG. 1 may include a brush (not illustrated) that cleans the conveyance mechanism 4. With this configuration, since the conveyance mechanism 4 includes the brush, the brush is brought into sliding contact with the rotating conveyance mechanism 4, and thus it is possible to efficiently perform cleaning by removing foreign substances such as paper dust and dirt.

### SIXTH MODIFIED EXAMPLE

The cleaning section 5 illustrated in FIG. 1 may include a wet cleaning unit (not illustrated) that cleans the conveyance mechanism 4.

With this configuration, since the conveyance mechanism 4 includes the wet cleaning unit, it is possible to remove foreign substances such as paper dust, ink and toner adhering to the conveyance mechanism 4 by replenishing the cleaning liquid and thus to enable long-term use.

### OTHER MODIFIED EXAMPLES

Further, at a peripheral portion of the conveyance drum 40, the conveyance mechanism 4 may include a heater (not illustrated) for heating the conveyance drum 40 and a suction device (not illustrated) for sucking ink dirt and the like adhering to the conveyance drum 40.

With this configuration, since the conveyance mechanism 4 includes the heater, it is possible to heat the conveyance drum 40 to soften the ink dirt adhering to the conveyance drum 40. Furter, since the conveyance mechanism 4 includes the suction device, it is possible to easily suck and remove the contamination of the ink softened by the heater. Therefore, the present invention can prevent the conveyance cylinder 41 from being unable to normally suck the recording medium 23 due to clogging of ink mist in suction holes (not illustrated) of the conveyance cylinder 41.

Although the embodiment and modified embodiments of the present invention have been described and illustrated in detail, the disclosed embodiments are made for purposes of illustration and example only and not limitation. The scope of the present invention should be interpreted by terms of the appended claims.

What is claimed is:

1. A conveyance section cleaning device comprising:
a recording medium conveyance unit that sucks and conveys a recording medium;
a cleaning section that cleans the recording medium conveyance unit; and
a controller that controls the cleaning section; wherein
if the recording medium is changed to one with a different size, the controller causes the cleaning section to clean the recording medium conveyance unit before printing starts.

2. The conveyance section cleaning device according to claim 1, wherein
if the recording medium is changed to a larger size, the controller causes the cleaning section to clean the recording medium conveyance unit before printing starts, and
if the recording medium is changed to a smaller size, the controller does not cause the cleaning section to clean the recording medium conveyance unit.

3. The conveyance section cleaning device according to claim 1, wherein
the controller does not cause the cleaning section to clean the recording medium conveyance unit if the size of the recording medium is not changed.

4. The conveyance section cleaning device according to claim 1, wherein
the controller does not cause the cleaning section to clean the recording medium conveyance unit if the number of printed sheets exceeds a preset number of printed sheets during printing.

5. The conveyance section cleaning device according to claim 1, wherein
the recording medium conveyance unit includes a conveyance drum that conveys the recording medium.

6. The conveyance section cleaning device according to claim 1, wherein
the recording medium conveyance unit includes a conveyance roller that conveys the recording medium.

7. The conveyance section cleaning device according to claim 1, wherein
the recording medium conveyance unit includes a conveyance belt that conveys the recording medium.

8. The conveyance section cleaning device according to claim 1, further comprising:
a sheet feed section that supplies the recording medium to the recording medium conveyance unit;
a sheet ejection section that ejects the recording medium on which printing has been performed;
a front/back reversing unit that reverses the recording medium; and
a sheet ejection/reversal switching unit that directs the recording medium either toward the sheet ejection section or toward the front/back reversing unit, wherein
the front/back reversing unit for double-sided printing is provided between the sheet ejection/reversal switching unit and the sheet feed section.

9. The conveyance section cleaning device according to claim 1, wherein
the cleaning section includes a cleaning roller that cleans the recording medium conveyance unit,
the cleaning roller is arranged in sections at positions corresponding to end portions on both sides in a width direction of the recording medium and a trailing end portion in a conveyance direction of the recording medium, and
at the position corresponding to the trailing end portion, only a cleaning portion of the cleaning roller contacts the recording medium conveyance unit.

10. The conveyance section cleaning device according to claim 1, wherein
the cleaning section includes an adhesive roller that cleans the recording medium conveyance unit.

11. The conveyance section cleaning device according to claim 1, wherein
the cleaning section includes an air ejecting unit that ejects air for cleaning the recording medium conveyance unit.

12. The conveyance section cleaning device according to claim 1, wherein
the cleaning section includes a brush that cleans the recording medium conveyance unit.

13. The conveyance section cleaning device according to claim 1, wherein
the cleaning section includes a wet cleaning unit that cleans the recording medium conveyance unit.

14. The conveyance section cleaning device according to claim 1, wherein
the cleaning section is provided upstream, just in front of the front/back reversing unit that reverses the recording medium.

15. An image forming apparatus comprising:
the conveyance section cleaning device according to claim 1; and
an image forming section that forms an image on the recording medium supplied from the recording medium conveyance unit.
